(19) United States
(12) Patent Application Publication
(10) Pub. No.: US 2025/0078044 A1
(43) Pub. Date: Mar. 6, 2025

(54) METHOD FOR DELIVERY, REMOVAL AND DISPOSAL OF CONSTRUCTION MATERIALS

(71) Applicant: Earth in Motion LLC, Virginia Beach, VA (US)

(72) Inventor: Garrett Tyler Johnson, Virginia Beach, VA (US)

(21) Appl. No.: 18/819,129

(22) Filed: Aug. 29, 2024

Related U.S. Application Data
(60) Provisional application No. 63/535,346, filed on Aug. 30, 2023.
(60) Provisional application No. 63/649,537, filed on May 20, 2024.

(51) Int. Cl. G06Q 10/30; G06Q 40/04

(52) U.S. Cl. CPC G06Q 10/30; G06Q 40/04

(57) ABSTRACT

The present invention provides a computer implemented method of matching partners for delivery, removal and disposal of construction materials. Construction materials may be moved to and from building sites utilizing heavy trucks such as dump trucks. The present invention matches purveyors of such vehicles in order to reduce environmental impacts from the movement of such trucks. The method includes electronically receiving a plurality of provider profiles, each profile comprising a provider's capabilities related to at least one of delivery, removal or disposal capabilities of construction materials. Once one of the providers identifies a need, that user sends a first request for matching identifying a need for at least one of delivery, removal or disposal of construction materials and the request is electronically received. A set of potential matches for the first request from the plurality of provider profiles based on the user's need and the provider's capabilities may be determined. At least one suitable match often based on minimizing environmental impact from the delivery, removal, or disposal sought may be identified. The identity of the at least one match provider may then be provided to the user. The match may also be taken into consideration adverse carbon footprint data and analysis and take into account the potential for obtaining or selling valuable carbon scores/credits.

### RELATED APPLICATION

The following application relates to a U.S. Provisional Application No. 63/535,346 filed Aug. 30, 2023, and 63/649,537 filed May 20, 2024, the disclosures of which are herein incorporated in their entireties by reference.

### FIELD OF THE INVENTION

The present invention relates to a computer implemented method of matching various partners for delivery, removal and disposal of construction materials.

### BACKGROUND

There is a need in the construction industry to more efficiently match vendors, purchasers, and the like when dealing with construction materials either at time of purchase or as waste. Companies in the construction industry are also more and more sensitive about its impact on the environment and on our nation's infrastructure. Much of construction material, whether new or waste, is transported using trucks, and particularly large and heavy dump trucks that use diesel fuel. Thus, their carbon footprint is high, and because of their weight tends to adversely affect infrastructure such as roadways and bridges. Thus, a means for matching construction material vendors, purchasers and the like would be desirable. Moreover, such matching will enable such people to take advantage of generating valuable carbon credits due to a positive carbon score for reducing the carbon footprint.

### SUMMARY

The present invention provides a computer implemented method of matching partners for delivery, removal and disposal of construction materials. Construction materials may be moved to and from building sites utilizing heavy trucks such as dump trucks. The present invention matches purveyors of such vehicles in order to reduce environmental impacts from the movement of such trucks. The method includes electronically receiving a plurality of provider profiles, each profile comprising a provider's capabilities related to at least one of delivery, removal or disposal capabilities of construction materials. Once one of the providers identifies a need, that user sends a first request for matching identifying a need for at least one of delivery, removal or disposal of construction materials and the request is electronically received. A set of potential matches for the first request from the plurality of provider profiles based on the user's need and the provider's capabilities may be determined. At least one suitable match often based on minimizing environmental impact from the delivery, removal, or disposal sought may be identified. The identity of the at least one match provider may then be provided to the user. The match may also be taken into consideration adverse carbon footprint data and analysis, and take into account the potential for obtaining or selling valuable carbon scores.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned features and other features and objects of the present invention and the manner of attaining them will become more apparent, and the invention itself will be best understood, by reference to the following description of one or more embodiments taken in conjunction with the accompanying drawings, wherein:

FIG. 1 is a flowchart of the process by which a provider provides the necessary information to become a registered provider.

FIG. 2 is a flowchart of the process according to one embodiment of the present invention in which partners are matched for delivery, removal and disposal of construction materials.

FIG. 3 is a flowchart of the process according to one embodiment of the present invention in which environmental impacts are considered in the process of matching partners.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

The present invention provides a computer implemented method of matching partners for delivery, removal and disposal of construction materials. In one embodiment, the method takes into account environmental impacts of the movement of construction materials from birth to grave of the construction materials. So-called partners in the construction material field may include manufacturers and/or sellers, buyers and disposal entities and may include utility contractors, site developers, builders, (both commercial and home), earth movers, directional drilling contractors, power companies, and the like. Such partners may be internal to a company such as a construction company that needs to deliver or dispose of a wide variety of materials to its various sites. By determining best match or matches, materials such as construction materials may be moved, delivered, supplied, disposed of and the like in a more efficient and cost effective manner while reducing negative environmental impacts such as decreasing the carbon footprint associated with the movement of the materials. With respect to the latter, the method of the invention may be used to generate opportunities to sell or trade carbon credits based on positive carbon scores related to the carbon footprint.

A carbon credit, also known as a carbon offset, is a tradable certificate or permit that represents the reduction, removal, or avoidance of one metric ton (1,000 kilograms) of carbon dioxide (CO2) emissions or its equivalent in other greenhouse gases (GHGs). The scores and credits are a key component of cap-and-trade systems and other market-based mechanisms aimed at reducing greenhouse gas emissions to combat climate change.

In an initial step, data from a multiplicity of partners or clients capable of delivering, removal, disposal of construction material and/or ability to sell or trade carbon credits is gathered, normalized and categorized. It is noted that partners capable of delivering may be in the form of a buyer, seller or operator, and such partners may have capabilities in all, or some aspects of the delivery, removal and disposal of construction materials. The so-called “partner” may also be an individual internal to the company in that a dispatcher may use the invention to identify a truck and/or truck driver particularly suited for performing the tasks of delivering, removal and/or disposal of construction waste.

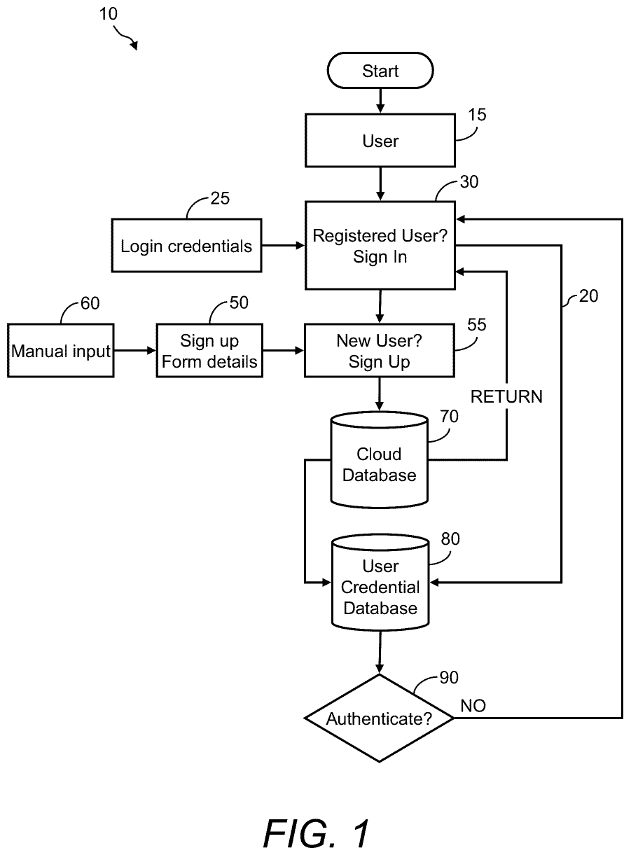

Referring to FIG. 1, a method 10 by which collection of data and normalization of data for the matching is shown. A potential partner/client/user 15 accesses the system via login credentials 25 and may be identified 30 as a registered user who may sign in 20 or sign up 50, once signed up/identified as a new user, the information stored on a computer database storage server 70 and which may be cloud-based. In the sign up process, the provider may manually input 60 a partner profile identifying a provider's capabilities related to at least one of delivery, removal, disposal capabilities of construction materials and/or ability to or want to trading/selling carbon credits based on positive carbon scores. Exemplary partner profile information to be inputted may include but is not limited to, personal information such as name, address, location and a password. The input may include, but is not limited to, business information such as name of business, place of incorporation/registered address, type of business, license number(s), list of capabilities and geography served. Additional information about stock management, pricing, specifics as to ordering, secure payment options, and the partner's security settings may be included, but not limited to. Any gaps in the data may be recognized and rectified either with a direct contact with the provider or through third-party sources. The system may also calculate the initial carbon footprint of the partner/client and its operations using algorithms and databases to provide an estimate of the footprint and carbon score. The resulting data may be saved on the computer storage server 70. In another embodiment, the above entry may be done manually.

The server 70 may be configured to analyze each of the profiles and of entities requesting a need for delivery, removal, disposal or sale/trade of carbon credits. The server 70 may form a pool of matching possible profiles. The server 70 may include a computer readable storage medium having computer code thereon for performing various computer-implemented operations and may be cloud-based. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The capabilities of the partner may include type of material wanted or able to supply and/or pick up/dispose. Exemplary types of material to purchase may include fill sand, top soil, beach sand, #57 gravel, pea gravel, #57 stone, #8 stone, #21 crusher run, half-inch crushed concrete, #57 crushed concrete, wood, lumber and the like. Exemplary materials to move or dispose of include any construction-based waste materials. The capabilities may also include the type of vehicle (e.g., truck) the partner has access to including whether gas-powered, diesel-powered, hybrid or electric.

The profile including the capabilities may be saved on the user credential and authenticated. The database may be reviewed periodically and authenticated 90. Once authenticated 90, a user may indicate they wish to buy, sell 95, pick-up 96, dispose or the like a particular construction material.

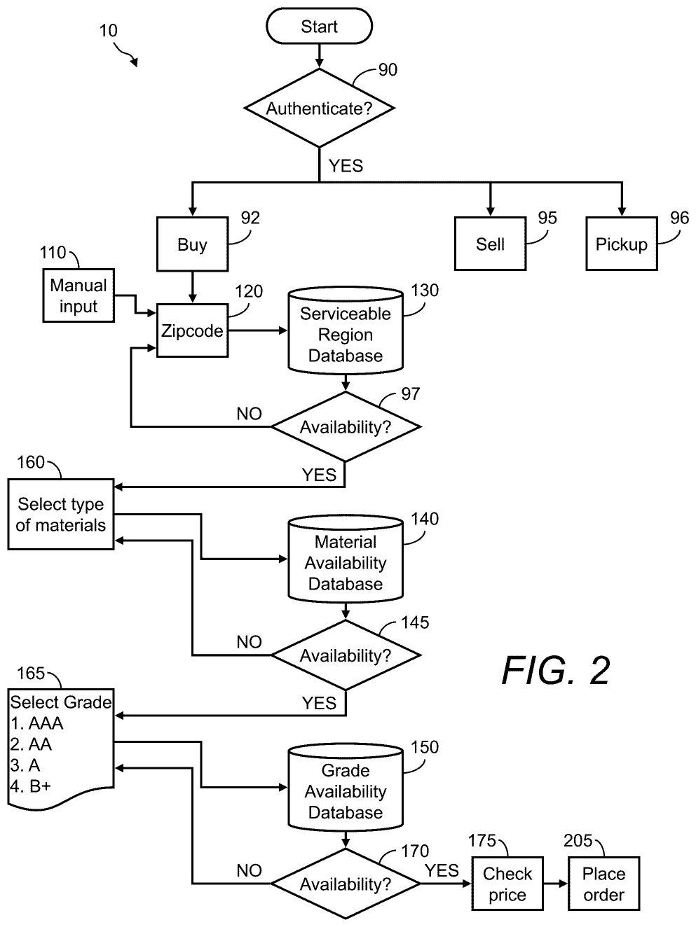

Referring to FIG. 2, a user or partner as a buyer, after indicating they wish to buy 92, a zip code as means of locating the buyer may be identified 120 and potential sellers in the zip code or zip codes availability 97 are identified in a serviceable region database 130. The zip code may be manually imputed 110. A serviceable region may be defined by a geographic radius or mileage to or from a site. After locating, the availability and capabilities of a partner, delivery of the purchased good may be evaluated and based on a wide variety of factors. These factors may include, but are not limited to:
1. Current Traffic Conditions including real-time delays including possible alternate routes and historical data on typical traffic patterns.
2. Elevation Data so that trucks that have difficulty on inclines may be routed efficiently.
3. Vehicle Information including weight, length, height and type of vehicle.
4. Weigh Stations including avoidance.
5. Fuel Stops including real-time gas prices or availability of charging stations.
6. Low Clearance hazards.
7. Tunnels including amount of tolls, lane restrictions and payment methods.
8. Low-Emission and No Brake Zones to avoid fines.
9. Speed Limits and Camera Alerts including real-time location of speed traps or check points.
10. Possible Alternative Routes to allow planning ahead for potential rerouting.
11. Carbon Footprint Data including historical emission data.
12. Weight and Length Restrictions.
13. Turn Restrictions.
14. Type of Road Surfaces including paved, gravel, dirt and whether under construction.
15. Hazmat Restrictions.
16. Area Restrictions including any area affected by a highly populated area or restricted area, such as related to national security, environmental concerns or security concerns.
17. Overall Environmental Impact

Potential providers may then be identified in the material availability database 140 and authenticated 145. If there are vehicles available in the identified zip code or zip codes 120 along with potential sellers or customers needing delivery of materials or disposal of material, the type of material is selected 160 and grade of material is selected 165. A typical standard of grade are the letter grades like AAA, AA, A and B+. The grade availability database 150 is checked for availability 170. The database may also be checked for whether carbon scores/credits are available if transportation of the materials reduces the carbon footprint. The server then may identify at least one suitable match. The particular partner with such profile is identified to the partner and the partner may contact the user meeting the partner's material needs, carbon score/credit needs and other characteristics and abilities of the partner, and agree on a price 175 such as price per pound, agree on an exchange of carbon scores/credits or if internal merely schedule the transportation.

If there is a match among buyer, location, material and desired grade, and reduction of carbon footprint/availability based on a carbon score, an order 205 based on a value check 190 of price grade of material and/or quantity may be placed 95. Once an order 205 is placed, delivery dates, types of payment, and the like are selected and the order placed 205. The logistics of pickup are then determined and a vehicle is dispatched to move the material. Payment may include the issuance of carbon credits based on the carbon score. Once dispatched, all aspects of the transportation of the materials may be monitored.

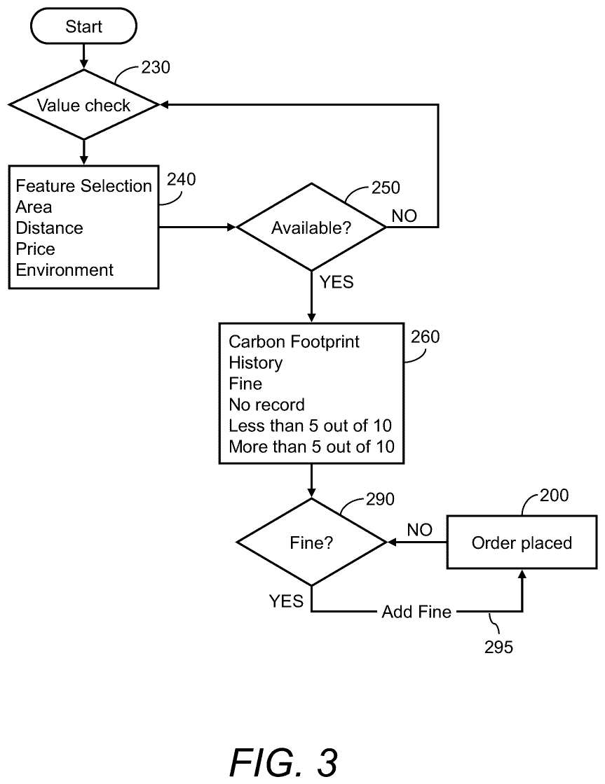

Referring to FIG. 3, a value check 230 includes evaluating 240 area to be delivered to, including distance and environmental impact. If the material is available 250 moveable and/or disposable, a carbon footprint analysis 260 is determined. The carbon footprint analysis 260 includes history, fines, availability of a carbon score and records. If a fine 290 has been imposed, the fine may be added to the order 295. With respect to environmental impact, data related to various actual and potential impacts may be inputted into the carbon footprint history 260.

Once a partner/client carbon footprint is calculated, the partner may list their carbon scores for sale if they have a surplus of scores/credits or for trade/purchase if need to offset the overall carbon footprint of their operations. The list of carbon scores may also include stock prices across a wide variety of domestic and foreign jurisdictions. The prices may be updated in real time. The system may be used to buy, sell, or trade carbon credits based on market conditions and the needs of the client or other customers.

Reports may be generated so that a partner/client may monitor their carbon credit transactions including reports on carbon off-setting achievements and portfolio performance. This information may also be useful or required for regulatory compliance and sustainability reporting.

The selection and finding of a partner may further include developing a computer application which in addition to providing the mapping capabilities, may also include useful information to the partner in real-time as the delivery or transport of materials is ongoing. For example, the following may be included, but not limited to, in the real-time application:
1. Points of interest such as food choices, truck shops and repair shops.
2. Voice navigation of turn-by-turn directions.
3. Management of documents needed in delivery such as load amounts, weights, buyer information, etc.
4. Gas prices along route.
5. Recharging stations.
6. Truck driving metrics like speed, braking patterns, idling, fuel consumption, tolls, etc., and allow feedback on the same.
7. DOT compliance like hours of services (HOS).
8. Reporting of accidents or other safety alerts.
9. Specifics about each vehicle including gas consumption.
10. Truck incentive programs for timeliness and the like.
11. Truck maintenance monitoring.
12. Truck expenses including repair.

In operation, the method may process available routes, take into account various vehicle constraints (weight, height, axle restrictions, etc.), and provide an optimum route options based on restrictions. The user may select a preferred route based on their own criteria such as distance, time of arrival, typical road conditions, traffic conditions and the like. Once the route is selected, real time updates and rerouting options may be used to avoid back-ups, construction, road closures and the like. After reaching the destination, the user may provide feedback based on accuracy of the route based on the constraints of the vehicle.

Although the present approach has been described herein with referenced to certain embodiments of the present invention, it is to be understood that the invention defined by the appended claims is not to be limited by particular details set forth in the above description as may perform similar functions and/or achieve like results. All such equivalent embodiments and examples are within the spirit and scope of the present approach.

1. A computer implemented method of matching partners for delivery, removal and disposal of construction materials while reducing negative environmental impacts from the movement of such construction materials, the method comprising:
electronically receiving a plurality of provider profiles, each profile comprising a provider's capabilities related to at least one of delivery, removal or disposal capabilities of construction materials;
electronically receiving a first request for matching from a user identifying a need for at least one of delivery, removal or disposal of construction materials;
determining a set of potential matches for the first request from the plurality of provider profiles based on the user's need and the provider's capabilities;
identifying at least one most suitable match based on minimizing environmental impact from the delivery, removal, or disposal sought; and
notifying the user of the identity of at least one matched provider.

2. The computer implemented method of claim 1, wherein the construction material comprises one or more of soil, rock, gravel, sand and dirt.

3. The computer implemented method of claim 1, wherein the construction material comprises waste wood, rock, sand and dirt.

4. The computer implemented method of claim 1, wherein the negative environmental impact comprises a negative carbon score.

5. The computer implemented method of claim 1, wherein the determining a set of potential matches includes determining what carbon scores and credits are available.

6. The computer implemented method of claim 5, wherein the carbon scores available are sold or traded as credits.
